(19) United States
(12) Patent Application Publication
(10) Pub. No.: US 2025/0136886 A1
(43) Pub. Date: May 1, 2025

(54) METHOD FOR IMPROVING GAS STORAGE CAPACITY OF NATURAL GAS HYDRATE BASED ON CRYSTAL REGULATION AND CONTROL PRINCIPLE

(71) Applicant: GUANGZHOU INSTITUTE OF ENERGY CONVERSION, CHINESE ACADEMY OF SCIENCES, Guangzhou (CN)

(72) Inventors: Xiaosen LI, Guangzhou (CN); Yisong YU, Guangzhou (CN); Jianwu LIU, Guangzhou (CN); Wenzhe SUN, Guangzhou (CN); Zhaoyang CHEN, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 18/705,601

(22) PCT Filed: Nov. 14, 2023
(86) PCT No.: PCT/CN2023/131467

§ 371 Date: Apr. 29, 2024

(30) Foreign Application Priority Data
Oct. 13, 2023 (CN) 202311323644.X

(51) Int. Cl. C10L 3/10; F17C 11/00

(52) U.S. Cl. CPC C10L 3/108; F17C 11/007; C10L 2200/04

(57) ABSTRACT

A method for improving gas storage capacity of a natural gas hydrate based on a crystal regulation and control principle is provided. A II structure was formed on the basis that a thermodynamic additive slightly soluble or insoluble in water was added to a hydrate generation system to compromise the hydrate generation conditions, and a crystal structure of the hydrate generated in the system was then regulated and controlled to be a I-type methane hydrate by controlling temperature and pressure. Therefore, the method for improving gas storage capacity of a natural gas hydrate is provided to creatively and fundamentally solve the problem of low gas storage capacity in the thermodynamic additive system.

### CROSS REFERENCE TO THE RELATED APPLICATIONS

This application is the national phase entry of International Application No. PCT/CN2023/131467, filed on Nov. 14, 2023, which is based upon and claims priority to Chinese Patent Application No. 202311323644.X, filed on Oct. 13, 2023, the entire contents of which are incorporated herein by reference.

### TECHNICAL FIELD

The present invention relates to the technical field of natural gas storage and transportation, and in particular to a method for improving gas storage capacity of a natural gas hydrate based on a crystal regulation and control principle.

### BACKGROUND

The hydrate-based natural gas solidified storage and transportation technology is a new natural gas storage and transportation technology developed in recent years, which is mainly a process of fixing natural gas in a solid hydrate phase on a large scale and storing and transporting it in the form of a solid natural gas hydrate. Traditionally, 1 m³ of a hydrate can store 160-180 m³ of natural gas under standard conditions. Compared with the traditional commercialized natural gas storage and transportation technologies such as liquefied natural gas (LNG) and compressed natural gas (CNG), the natural gas hydrate solidified storage and transportation technology has the advantages of short process, low cost, safety and no pollution, etc. However, the core problems that restrict further industrialization of this technology mainly include the following two aspects: extremely high conditions for generation of the natural gas hydrate, and low gas storage capacity of the natural gas hydrate. As for the problem in the first aspect, researchers mainly compromise generation conditions of the natural gas hydrate by introducing a thermodynamic additive. It is worth noting that the current study shows that adding the thermodynamic additive may be the effective and only way to compromise the generation conditions of the natural gas hydrate. However, since the thermodynamic additive itself may take up a part of the clathrate space of the hydrate, clathrate space of the hydrate provided for gas molecules to take up are reduced, and then the gas storage capacity of the hydrate is reduced.

Some researchers have proposed to enhance the gas-liquid mass transfer process by means of using a kinetic accelerator and a dispersant, stirring, bubbling and spraying, etc. so as to achieve the purpose of increasing the apparent total gas storage capacity. The patent “HYDRATE ACCELERANT AND APPLICATION THEREOF IN PREPARING HIGH-GAS-STORAGE-DENSITY GAS HYDRATE” (Publication Number: CN104974713A) proposes to promote generation of a gas hydrate by use of aqueous solutions of amino acids with different concentrations, of which the result shows that the gas storage capacity and the gas storage density can be increased to a certain extent. The patent “LOW ENERGY CONSUMPTION WATER-AIR SEPARATION DEVICE AND METHOD” (Publication Number: CN104841237B) proposes to promote generation of a gas hydrate by use of one or more of several kinetic accelerators and thermodynamic accelerators in concert. The article “Research Progress of Enhanced Generation Technology and Method of Natural Gas Hydrate [J]. Oil and Gas Storage and Transportation, 2012, 31(10):725-732” summarizes promotion of stirring, bubbling and spraying, etc. to generation of the gas hydrate and the influence of stirring, bubbling and spraying, etc. on gas storage capacity. Although these methods can improve the gas storage capacity of the gas hydrate to a certain extent, they are all achieved by forming more gas hydrates. Therefore, it is urgent to develop a method that can fundamentally solve the problem of low gas hydrate storage capacity in a thermodynamic additive system by adjusting the crystal structure of the natural gas hydrate without generating more natural gas hydrates.

A natural gas hydrate is a kind of clathrate, with water molecules as the main body, forming a spatial lattice structure, and gas molecules as objects, filling cavities between the lattices, and there is no stoichiometric relationship between gas and water. The water molecules forming the lattices are bonded by strong hydrogen bonds, while the force between gas molecules and water molecules is Van der Waals force. At present, there are four kinds of hydrate structures found, namely, I type, Il type, H type and T type. The I-type hydrate is of a cubic crystal structure, and due to the small volume of its inner cavity, crystal cavities have the average diameter of 0.78 nm, and can only accommodate small molecules such as methane, ethane, nitrogen, carbon dioxide and hydrogen sulfide. The I-type hydrate is most widely distributed in nature, and the hydrates of pure methane and pure ethane are I type. The general composition of this methane hydrate is CH₄.5.75H₂O. The II-type hydrate is of a rhombic crystal structure, and its larger cavities tend to contain hydrocarbon molecules such as propane (C3) and isobutane (i-C4) in addition to small molecules of C1 and C2. The H-type hydrate is of a hexagonal crystal structure, and its cavities can even contain i-C5 molecules and other molecules with a diameter of 0.75-0.86 nm. By analyzing the four structural characteristics of the natural gas hydrate, it can be seen that the ratios of small crystal cavities to large crystal cavities of type I, type II, type H and type T are 1:3, 2:1, 5:1 and 1:4 respectively. If methane takes up I-type 5¹² and 5¹²6², the I-type hydrate has the maximum methane storage capacity.

### SUMMARY

An objective of the present invention is to provide a method for improving gas storage capacity of a natural gas hydrate based on a crystal regulation and control principle, which solves the problem of low gas storage capacity of the natural gas hydrate in a thermodynamic additive system.

The present invention is achieved by the following technical solutions.

A method for improving gas storage capacity of a natural gas hydrate based on a crystal regulation and control principle includes: introducing a thermodynamic additive slightly soluble or insoluble in water such that methane molecules replace additive molecules to take up a large lattice (5¹²6⁴) in a II-type hydrate so as to generate a II-type pure methane hydrate (16(5¹²)·8(5¹²6⁴)·136H₂O); and quickly transforming the unstable II-type pure methane hydrate (16(5¹²)·8(5¹²6⁴)·136H₂O) into a I-type pure methane hydrate (2(5¹²)·6(5¹²6²)·46H₂O) by controlling a temperature to 274.15-288.15 K and a pressure to 5-9 MPa.

The thermodynamic additive slightly soluble or insoluble in water, mentioned in the present invention, refers to a generation accelerator which can usually form a II-type hydrate with methane. For example, cyclopentane, propane and trimethylene sulfide in a traditional thermodynamic additive can meet this demand.

Owing to the low solubility in water, the solubility of the thermodynamic additive slightly soluble or insoluble in water changed little in a water solution no matter how much it was added. Therefore, the addition of the thermodynamic additive slightly soluble or insoluble in water had less effect on compromising the hydrate generation conditions in the whole system. Thus, the regulation solution can meet the requirements of large-scale crystal regulation and control, and is suitable for the development requirements of large-scale industrial application.

The crystal regulation and control principle of the hydrate is described as follows: according to the traditional van der Waals and Platteeuw theories, when the cavity occupancy rate (θ_{L}(Gas)) of gas molecules in a lattice 5¹²6⁴ was higher than that the cavity occupancy θ_{L}(Promoter) of additive molecules in the lattice 5¹²6⁴, the gas molecules could replace the additive molecules to take up a large clathrate space of the II-type hydrate. The cavity occupancy rate (θ_{L}) was calculated by the formula θ_{Li}=C_{Li}Pᵢ/(1+C_{L1}P₁+C_{L2}P₂), where C_{Li} is Langmuir adsorption coefficient and Pᵢ is differential pressure of guest molecules (gas or additive). In order to meet the condition θ_{L}(Gas)>θ_{L}(Promoter), it is necessary to increase the system pressure or reduce the solubility of the additive around a hydrate growth point in water. Therefore, choosing a slightly soluble or insoluble thermodynamic additive is an effective way to replace the additive molecules with methane molecules to form a methane hydrate. In addition, the research shows that a II-type CH₄ hydrate itself is unstable under the medium and low pressure conditions, and may be spontaneously transformed into a stable I-type hydrate, and the progress rate of this process is affected by the degree of supercooling of the system. By adjusting the degree of supercooling, the II-type methane hydrate can be quickly transformed into the I-type methane hydrate.

It is worth mentioning that according to the present invention, the thermodynamic additive molecules fail to take up the clathrate space of the I-type hydrate because of their large molecular diameters.

Therefore, the thermodynamic additive slightly soluble or insoluble in water and capable of forming a II-type structure with methane was selected for the present invention.

Preferably, the volume ratio of the thermodynamic additive slightly soluble or insoluble in water to water was (15-24):(76-85).

The crystal regulation and control process of the hydrate is universally applicable and does not need to be achieved by other auxiliary devices.

The process of controlling pressure and temperature conditions in step 2 was achieved by a cooling and heating device, and its specific process depends on the thermodynamic additive used.

When the thermodynamic additive slightly soluble or insoluble in water was cyclopentane, the pressure was 5-9 MPa and the reaction temperature was 274.15-288.15 K.

When the thermodynamic additive slightly soluble or insoluble in water was commonly used propane, the pressure was 5-7 MPa and the reaction temperature was 276.15-283.15 K.

The method for improving gas storage capacity of a natural gas hydrate according to the present invention is mainly achieved by regulating and controlling the crystal structure of the hydrate generated in the system. By regulating and controlling the crystal structure of the hydrate, the problem of low gas storage capacity of the hydrate in the thermodynamic additive system can be fundamentally solved.

Therefore, the present invention also protects application of the method for improving gas storage capacity of a natural gas hydrate based on the crystal regulation and control principle to natural gas storage and transportation.

The present invention has the following beneficial effects.

According to the present invention, a II structure was formed on the basis that a thermodynamic additive slightly soluble or insoluble in water was added to a hydrate generation system to compromise the hydrate generation conditions, and the crystal structure of the hydrate generated in the system was then regulated and controlled to be a I-type methane hydrate by controlling temperature and pressure. Therefore, the method for improving gas storage capacity of a natural gas hydrate is provided to creatively and fundamentally solves the problem of low gas storage capacity in the thermodynamic additive system.

The present invention can be suitable for large-scale generation of the gas hydrate, and can meet industrial development requirements of the hydrate-based natural gas solidified storage and transportation technology.

The present invention does not require introduction of other devices or auxiliary apparatuses, can neither reduce the effect of the additive on compromising the hydrate generation conditions nor cause a significant increase in cost, and thus has wide applicability.

### BRIEF DESCRIPTION OF THE DRAWINGS

FIG. 1A is a PXRD spectrum of a pure cyclopentane (CP) hydrate; FIG. 1B is a PXRD spectrum of a natural gas hydrate obtained in Embodiment 1; and

FIG. 2 is a PXRD spectrum of a natural gas hydrate obtained in Embodiment 3.

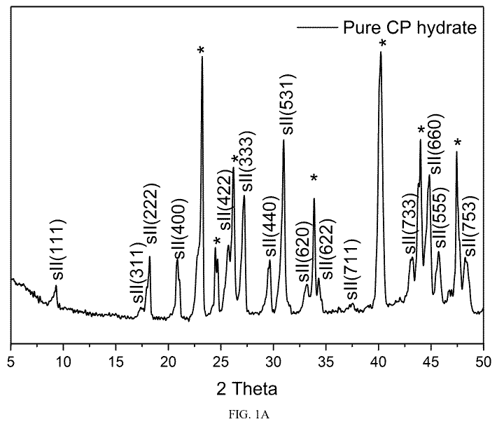

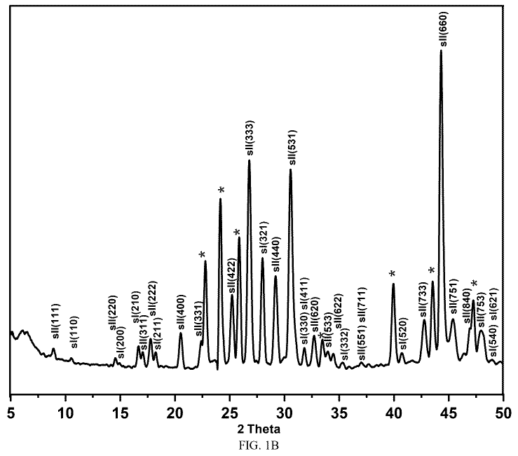

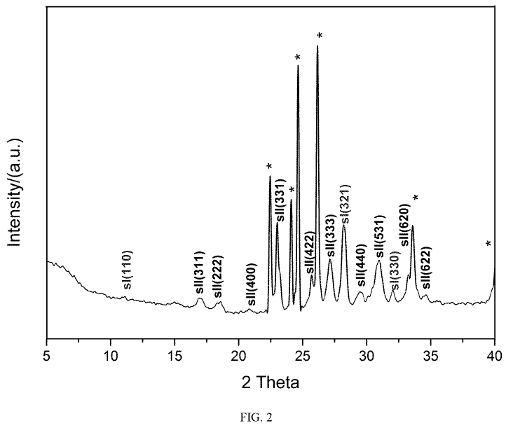

### DETAILED DESCRIPTION OF THE EMBODIMENTS

The following is a further explanation of but not a limitation to the present invention.

### Embodiment 1

Based on a total volume of 100 mL, 76 mL of water and 24 mL of cyclopentane were measured with a graduated cylinder and placed in a high-pressure gas hydrate reactor (400 mL); upon completion, methane gas was introduced to purge the hydrate reactor to remove air in the reactor; and subsequently, methane was introduced into a system as a reaction gas and pressurized to 8.0 MPa. The reaction temperature was changed cyclically between 274.15 K and 288.15 K as required, with a single cycle time of 1.0 h. The gas storage capacity of the hydrate reached 152 V/V after the reaction of the hydrate lasted for 5.0 h. X-ray powder diffraction results showed that there were a II-type pure methane hydrate and a I-type pure methane hydrate in the generated hydrate system.

### Embodiment 2

Based on a total volume of 100 mL, 85 mL of water and 15 mL of cyclopentane were measured with a graduated cylinder and placed in a high-pressure gas hydrate reactor (400 mL); upon completion, methane gas was introduced to purge the hydrate reactor to remove air in the reactor; and subsequently, methane was introduced into a system as a reaction gas and pressurized to 8.0 MPa. The reaction temperature was changed cyclically between 276.15 K and 283.15 K as required, with a single cycle time of 1.0 h. The gas storage capacity of hydrate reached 124 V/V after the reaction of the hydrate lasted for 5.0 h. X-ray powder diffraction results showed that there were a II-type pure methane hydrate and a I-type pure methane hydrate in the generated hydrate system.

### Embodiment 3

Based on a total volume of 100 mL, 20 mL of water was measured with a graduated cylinder and placed in a high-pressure gas hydrate reactor (400 mL); upon completion, methane gas was introduced to purge the hydrate reactor to remove air in the reactor; and subsequently, a methane+propane gas mixture was introduced into a system as a reaction gas and pressurized to 6.0 MPa. The reaction temperature was changed cyclically between 276.15 K and 283.15 K as required, with a single cycle time of 1.0 h. The gas storage capacity of hydrate reached 124 V/V after the reaction of the hydrate lasted for 5.0 h. It was worth noting that since the molar fraction of propane in the components of commercial natural gas was about 0.72 mol %, the molar fraction of propane in the methane+propane gas mixture in this embodiment was also 0.72 mol %. X-ray powder diffraction results showed that there were a II-type pure methane hydrate and a I-type pure methane hydrate in the generated hydrate system.

What is claimed is:

1. A method for improving a gas storage capacity of a natural gas hydrate based on a crystal regulation and control principle, comprising: introducing a thermodynamic additive slightly soluble or insoluble in water to generate a II-type pure methane hydrate, wherein the II-type pure methane hydrate is an unstable II-type pure methane hydrate;
and quickly transforming the unstable II-type pure methane hydrate into a I-type pure methane hydrate by controlling a temperature to 274.15-288.15 K and a pressure to 5-9 MPa.

2. The method according to claim 1, wherein the thermodynamic additive slightly soluble or insoluble in the water is one selected from cyclopentane, propane, and trimethylene sulfide.

3. The method according to claim 1, wherein a volume ratio of the thermodynamic additive slightly soluble or insoluble in the water to the water is (15-24):(76-85).

4. The method according to claim 1, wherein when the thermodynamic additive is cyclopentane, the pressure is 7-9 MPa and the temperature is 274.15-288.15 K.

5. The method according to claim 1, wherein when the thermodynamic additive is propane, the pressure is 5-7 MPa and the temperature is 276.15-283.15 K.

6. The method according to claim 1, wherein the method is applied in a natural gas storage and transportation.
